(19) United States
(12) Patent Application Publication
(10) Pub. No.: US 2026/0009281 A1
(43) Pub. Date: Jan. 8, 2026

(54) RETROFIT THERMALLY INSULATING MEMBER FOR A RECONFIGURABLE FENESTRATION ASSEMBLY

(71) Applicant: 3E NANO INC., Toronto (CA)

(72) Inventors: Jose NUNEZ-REGUEIRO, Ann Arbor, MI (US); Nazir Pyarali KHERANI, Toronto (CA); Alexey KRASNOV, Canton, MI (US)

(21) Appl. No.: 19/237,254

(22) Filed: Jun. 13, 2025

Related U.S. Application Data
(60) Provisional application No. 63/667,612, filed on Jul. 3, 2024.

(51) Int. Cl. E06B 3/28; E06B 9/24

(52) U.S. Cl. CPC E06B 3/28; E06B 9/24; E06B 2009/2417

(57) ABSTRACT

A frameless thermally insulating member comprising a single or composite optically transparent pane and supporting a thermally insulating element can be removably and interchangeably fitted in an insect screen compartment of an existing window or between the compartment and the main window, thus making the system reconfigurable to optimize its functionalities. The screen can be used when the weather permits the window to stay open. It can be effortlessly replaced by the thermally insulating member during hot and cold seasons to manage the amount of direct sunlight entering the building radiatively as well as the amount of heat exchange between the building and the outdoor environment due to convection and conduction. Alternatively, a modified version of the retrofit may be used along with the insect screen. In addition to its thermal performance, the thermally insulating member may be designed to add to the window aesthetic appeal. All these attributes as well as its compatibility with a broad variety of existing fenestration designs makes the presented retrofit an attractive option for reconfigurable fenestrations from the viewpoint of thermal performance, aesthetics, affordability, and convenience of use alike.

### FIELD

The present disclosure relates to architectural fenestrations and particularly to a lightweight thermally insulating member enabling an economical and easily reconfigurable retrofit solution to an existing window comprising an insect screen compartment.

### BACKGROUND

The thermal insulation of commercial and residential fenestrations is of growing importance from both energy savings and environmental preservation points of view. This attribute is typically quantified in terms of the R-value—a measure of how well a window resists the conductive flow of heat. Typical windows are either a single pane of glass supported by a frame or an insulating glass unit (IGU) supporting two or three panes of glass (U.S. Pat. No. 5,557,462A, US20220363033A1). If the glass has no special coating deposited on it, the R-value for such windows would respectively be measured around 1, 2, and 3. Adding a solar-control low-emissivity (low-E) coating (EP0717014B1, https://doi.org/10.1016/j.optmat.2023.113807) on one or more panes and filling the cavity (the space between glass panes) with an inert gas (U.S. Pat. No. 9,540,863B2) can, for example, increase the R-value of double- and triple-pane windows respectively to approximately 4 and 8, albeit at an increased price premium. Many commercial and residential windows, including sliding and awning windows, are equipped with removable insect screens located in their screen compartments and secured in place by a set of clips. Insect screens are useful to keep insects out only when the weather is comfortable for windows to stay open. For many geographical locations, there are cold and hot seasons when windows stay closed most of the time.

Upgrading existing low-performance windows with thermally efficient ones is known to incur a high upfront cost which leads to a long payback time. In such instances as buildings of historic significance, for example, replacing original fenestrations may not only be justifiable but also not permitted.

The above-mentioned solar-control low-E coatings function by partially blocking the near-infrared (near-IR) portion of direct sunlight and can be divided into low-gain and high-gain coatings which respectively allow less and more radiative energy of the sun to pass through the window. The former are beneficial for thermal comfort of building occupants in hot summer days to keep both direct solar (the near-IR radiation) and thermal (related to mid-IR radiation) heat out, while the latter are designed to allow more direct sunlight energy to enter the building during cold winter days and, at the same time, to keep heat in the building. Silver-based solar-control coatings are the most efficient and commonly used in the industry; these coatings are traditionally deposited—due to their susceptibility to environmental corrosion and mechanical damage—on the surface of a glass pane which is enclosed and faces the IGU cavity. A solar-control coating typically comprises one or more thin layers of silver or silver alloy embedded in a thin-film stack of dielectrics. For this reason, this type is often referred to as a “soft” coating. However, recent advancements in making silver-based solar-control coatings more environmentally stable and less susceptible to mechanical damages (U.S. Ser. No. 11/685,688B2, CA3061105A, CN103802379) offer the promise of using them on surfaces exposed to air. Non-silver-based coatings, such as pyrolytically deposited fluorine-doped tin oxide (FTO) or sputtered indium-tin-oxide (ITO) and indium zinc oxide (IZO) are examples of much more robust and environmentally stable, although not as efficient as silver-based, class of IR-blocking materials referred to as transparent conducting oxides (TCOs). Both types may help to suppress not only the direct radiative portion of the sunlight but also to reduce the conduction heat transfer through fenestration caused by mid-IR radiation. For this reason, a TCO coating, often denoted as a “hard” coating, is sometimes disposed on the interior surface of the window. Unfortunately, retrofitting an installed window with either coating type is impossible.

One of the affordable alternatives to replacing an existing underperforming window is to make it more energy efficient with the help of a retrofit insert. This also may solve the problem of interfering with the building envelope of historically important structures. Such inserts are known in the art. US20230084137A1, for example, discloses an insert comprising a polymer film supported by a frame which is permanently attached to the frame of an existing window. Similarly, U.S. Pat. No. 9,234,381 B2 discloses a supplemental window insert comprising a frame which supports a plastic film stretched across it. The supplemental window uses an external mechanism which enables attaching it to the main window. U.S. Ser. No. 11/905,753B2 discloses a retrofit glazing system comprising a support frame which is attached to the frame of an existing window using a structural adhesive, a fastener, a lock handle, or a latch. The supplemental frame is contiguous with the main window frame and is equipped with special clamps allowing it to be snapped onto the main window frame. Alternative fastener types include suction cups or an adhesive. US20160145934A1 discloses a retrofit system which acts as a mechanically protective shield and is permanently attached to it with an adhesive. U.S. Pat. No. 9,663,983B2 discloses a supplemental plastic window which, although referred to as frameless, comprises supporting braces at the corners of the plastic pane for added rigidity. The supplemental window also comprises an attachment mechanism for fastening it to the frame of the main window. U.S. Pat. No. 9,606,409B2 uses an electrochromic insert supported by a rigid scaffolding which is permanently affixed to a preexisting window using a structural adhesive. Retrofit inserts may also be made using laminated composites comprising bonded plastic and glass panes [https://fis.tu-dresden.de/portal/en/publications/neerofacade—a-new-concept-of-facade-design-with-lightweight-thin-glassplasticcomposite-panels(48c37354-e449-4f49-aadb-57eca148f625).html].

The three elements common for the prior art related to retrofitting an existing underperforming window with an energy-efficient insert, therefore, are 1) a supplemental frame or a set of additional mechanisms, such as braces, that support the pane or plastic film of the insert, 2) additional attachment means, such as adhesive, clamps, fasteners, etc., required by said supplemental frame to be attached to the frame of the existing window, and 3) a force vector applied to the insert and generated by said additional attachment means towards the existing window. The first element adds additional weight, dimensions, and complexity to the structure—the frame must be fabricated with tight tolerances to precisely fit around the main frame of the window to prevent thermal leakage. The second element requires the steps of fabrication, attachment, and installation of additional fastening devices, adds installation labor costs, as well as makes the retrofit both aesthetically and mechanically intrusive to the building envelope. It also inevitably adds thickness to the existing window from the interior side and, in the case of using a plastic film stretched across the supplemental frame, makes the insert susceptible to mechanical damage. Besides, the dimensions of existing windows must be precisely measured, and retrofits must be customized at the end user site. For this, one or more trips from an installation technician is required, thus further increasing the upfront cost. The third element limits the design options to those placing the insert in immediate proximity to the main window.

It would be desirable, therefore, to provide an optically transparent and clear insert design which overcomes the abovementioned deficiencies of prior art and offers an economical and flexible thermally insulating retrofit solution to existing windows.

### SUMMARY

The present disclosure provides a thermally insulating member for retrofitting in a reconfigurable manner into an existing window, the window originally including an exterior window pane, an interior window pane spaced from the exterior window pane forming a space between the interior window pane and the exterior window pane with the interior window pane facing into an interior of a building, and an insect screen compartment adjacent to, and spaced away from the interior window pane on the side of the interior window pane facing the interior of a building, the insect screen compartment sized and configured to contain a removable insect screen and being equipped with a set of original securing clips, the thermally insulating member comprising:
an optically transparent pane sized and configured to be removably secured into the insect screen compartment by said set of original securing clips when the insect screen has been removed or in the space between the interior window pane and the insect screen compartment whether or not the insect screen is present in the insect screen compartment; and
a thermally insulating element permanently attached to said optically transparent pane on one side thereof with the other side of the thermally insulating element bearing against the surface of the interior window pane, and wherein the thermally insulating element includes a biasing mechanism to push the optically transparent pane away from the interior window pane and towards the insect screen compartment.

The thermally insulating element may be a compressible strip extending around the periphery of the optically transparent pane, wherein the biasing mechanism is provided by the compressibility of the compressible strip.

The thermally insulating element may be compressible pillars with one end thereof mounted to the optically transparent pane and the other end bearing against the interior window pane. There may be four of these compressible pillars located at the corners of the optically transparent pane.

The compressible pillars may comprise a piston inserted into a barrel and attached to a spring located in the barrel, with pads and placed with the end of one pad bearing against the optically transparent pane and the end of the other pad bearing against the interior window pane, wherein the biasing mechanism is provided by a spring.

The optically transparent pane may be made of a polymer, and further comprising a thin glass pane bonded to one side of the optically transparent pane, and wherein the other side of the optically transparent pane is permanently attached to the thermally insulating element.

The thermally insulating member may further comprise a solar-control and, or a low-E coating sandwiched between the thermally insulating element and the optically transparent pane. This solar-control coating may comprise a layer of silver having a thickness in a range from about 10 to about 20 nm sandwiched between two layers of aluminum nitride, each about a thickness in a range from about 15 to about 45 nm. The layer of silver may be about 15 nm thick, and wherein the two layers of aluminum nitride each may have a thickness of about 35 nm.

The thermally insulating member may further comprise a solar-control coating sandwiched between the optically transparent pane and the thin glass pane. This solar-control coating may comprise a layer of silver having a thickness in a range from about 10 to about 20 nm, sandwiched between two layers of aluminum nitride, each about a thickness in a range from about 15 to about 45 nm. This layer of silver may be about 15 nm thick, and wherein the two layers of aluminum nitride each may have a thickness of about 35 nm.

The thermally insulating member may further comprise a solar-control coating sandwiched between the optically transparent pane and the thin glass pane, and a low-emissivity coating applied on the surface of the thin glass pane facing the interior of the building.

The thermally insulating member according to claim 13, wherein the solar-control coating comprises a layer of silver having a thickness in a range from about 10 to about 20 nm, sandwiched between two layers of aluminum nitride, each about a thickness in a range from about 15 to about 45 nm. This layer of silver may be about 15 nm thick, and the two layers of aluminum nitride each may have a thickness of about 35 nm.

The optically transparent pane may be made of polymethyl methacrylate.

The optically transparent pane may be a single uncoated optically transparent pane made of polymethyl methacrylate with a thickness from about 1 to about 16 mm.

The optically transparent pane may be a single optically transparent pane made of polymethyl methacrylate coated on its surface facing the interior of the building with a low-emissivity coating and having a thickness from about 1 to about 16 mm.

The low-emissivity coating may comprise an indium tin oxide layer.

The optically transparent pane may be a composite made of a polymethyl methacrylate pane, about 2 to about 10 mm thick, bonded with a glass pane, having a thickness in a range from about 0.025 to about 2 mm thick.

The thermally insulating member may further comprise a solar-control coating located on a surface of exterior window that faces into the building.

The thermally insulating member may comprise a clear polymethyl methacrylate pane coated with a solar-control coating and having a thermally insulating element permanently attached to said optically transparent pane on the surface having the solar-control coating applied thereto and being installed in an insect screen compartment of a window instead of an insect screen with the surface of the clear polymethyl methacrylate pane having the solar-control coating located thereon facing the exterior window.

The present disclosure provides window unit, comprising:
an exterior window pane, an interior window pane spaced from the exterior window pane forming a space between the interior window pane and the exterior window pane with the interior window pane facing into an interior of a building, and an insect screen compartment adjacent to, and spaced away from the interior window pane on the side of the interior window pane facing the interior of a building, the insect screen compartment sized and configured to contain a removable insect screen and being equipped with a set of original securing clips;
a thermally insulating member comprising an optically transparent pane sized and configured to be removably secured into the insect screen compartment by said set of original securing clips when the insect screen has been removed or in the space between the interior window pane and the insect screen compartment whether or not the insect screen is present in the insect screen compartment; and
a thermally insulating element permanently attached to said optically transparent pane on one side thereof with the other side of the thermally insulating element bearing against the surface of the interior window pane, and wherein the thermally insulating element includes a biasing mechanism to push the optically transparent pane away from the interior window pane and towards the insect screen compartment.

The window unit may further comprise a solar-control coating located on a surface of exterior window that faces into the building.

### BRIEF DESCRIPTION

The present disclosure solves the shortcomings of the abovementioned prior art by providing a lightweight, truly frameless, economical, easy-to-install, and easy-to-remove retrofit thermally insulating member (TIM) designed to temporarily replace the insect screen of an existing window to improve its thermal insulation in existing built environment. Said TIM may be removably secured in place using an existing set of clips located on the frame of the screen compartment, thus transforming, for example, a dual pane insulated glass unit into a highly performing triple pane window. Alternatively, certain designs do not require the screen to be removed from the compartment. They provide means to generate pressure to the TIM from the existing window side; this enables the TIM to work alongside the screen. In this case, the TIM may even comprise vents to provide air flow between the building and outdoor environment and, at the same, to keep the insects from entering the building interior.

Remarkably, the dimensions of the TIM are not subjected to tight tolerances, as compared to the retrofits of prior art. The only requirement is that the pane must be slightly smaller than the screen compartment to ensure its comfortable fitting during expansion and contraction caused by temperature variations. The frameless TIM supports a thermally insulating element (TIE) designed, unlike the solutions of prior art, to create a force (sometimes also referred to as force vector) to push the TIM away from the main window and against the frame of the screen compartment or the screen itself—depending on whether the end user chooses to remove the screen from the frame before installing the TIM. In other words, the force vector of the TIE action is directed away from the main window and towards the screen compartment. The TIE is appropriately secured onto the pane of the TIM, typically proximal to its perimeter.

Additionally, to its primary function, the TIE, due to its compressible nature, inherently accommodates the dimensional variability of a given compartment as well as variability in distance between different areas of the compartment to the main window.

In an embodiment, the TIE comprises four spring-assisted pillars attached to, for example, the four corners of the retrofit pane made of a lightweight material, such as plastic, and coated with a solar-control coating. The insect screen remains in the compartment and is secured in it from the building interior side by a set of existing clips. Upon the insertion of the TIM between the main window and the screen, the pillars create pressure to push the pane against the screen or the frame of the compartment to secure it. From the opposite side of the compartment, the TIM is secured by the existing set of clips. Additional pillars may be included for greater support depending on the dimensions of the TIM.

In an embodiment, the insect screen is removed from the compartment and is replaced by the TIM which is pushed by the pillars away from the main window and against the frame of the compartment.

In an embodiment, the TIE is made in the form of a compressible strip attached to the TIM along the entire length of its perimeter and proximal to the edges of the insert. The role of the TIE in this case is twofold: 1) to push the pane of the TIM against the insect screen or the frame of the screen compartment and 2) to create an isolating airspace between the retrofit pane and the main window, thus reducing thermal transfer caused by convection and conduction in addition to the main role of the coated pane as a near-IR blocker. In this embodiment, the TIE is preferably made of a conformal material, such as silicone, polyurethane, nitrile rubber, neoprene, butyl rubber, etc. which allows the TIE to be slightly compressed between the main window and the pane of the TIM.

In an embodiment, the TIM may comprise a vent or a set of vents to enable air circulation between the building interior and the outdoor environment while the screen keeps insects out from entering the building.

Although the transparent pane of the retrofit TIM adjoins the frame of the main window in some places, it is not attached to it with adhesive or any kind of fasteners. On the contrary, the pane of the TIM is pushed away from the main window by the pressure provided by the TIE, and this pressure secures the TIM in place with additional support of the existing clips of the screen compartment and without the need of any added means of fastening. In other words, the force vector of the TIE action is directed away from the main window and towards the screen compartment. This is a key difference of the present disclosure from prior art. Also, the TIM is not specifically designed to provide tight contact with the frame for its thermally insulating functionality. It is designed to be an economical yet adequate solution to reduce heat convection and conduction, while primarily serving the function of blocking direct IR light. The option of compressible TIE arranged along the entire perimeter of the TIM, however, does additionally and advantageously reduce the heat transfer by entrapping a volume of air between the retrofit pane and the main window. The fact that the TIE is pressed against the surface of the innermost pane of the window and not its frame significantly relaxes the dimensional tolerance requirements for the TIM and enables its easy and inexpensive manufacture as well as do-it-yourself installation by the end user without any professional help.

As an example, and without any limitations, the insect screen may remain in its compartment when the weather is comfortable for the window to stay open to allow air flow. During stretches of hot sunny weather, insect screens may be effortlessly replaced by the end user with low-gain solar-control coated TIM inserts to maximize the blockage of both near-IR and mid-IR sun radiation. High-gain TIM inserts may be installed during cold winter months to maximize energy savings by allowing more direct sun energy into the building while preventing the escape of mid-IR radiation. There is an option, of course, to have just one type of TIM insert which performs adequately in both hot and cold seasons. One may think of it, for example, as the analogy of using winter and summer tires for top-notch seasonal performance as opposed to using a set of all-season tires which nevertheless provide adequate performance throughout the year.

Other added values of the TIM may include an improved aesthetic appeal by applying to it, for instance, a decorative grille—a set of orthogonal strips dividing the window into smaller sections—(https://www.jeld-wen.com/en-us/discover/reference/guide-to-window-grilles) or a customized logo (for example, a logo of a favorite sports team).

The transparent pane of a TIM can commercially be cut to size from prefabricated coated panes or pane composites by a glass or plastic contractor using the dimensions provided by the end user, for example, using a dedicated online site. After the attachment of a TIE, the TIM may be shipped to or picked up by the end user for DIY installment. A TIM may be packaged in a corrugated cardboard box or another suitable packaging material for shipping and/or handling and may additionally be protected from one or both sides with a removable adhesive tape. Alternatively, TIMs may be installed by a professional.

In an embodiment, the present disclosure presents a TIM comprising a single pane of optically transparent and optically clear plastic coated with a solar-control and/or low-emissivity (low-E) coating. Examples of plastic include polycarbonate (PC), polymethyl methacrylate (PMMA), polyethylene terephthalate (PET), cellulose acetate, polyvinyl chloride, etc. It is worth noting in this regard that PMMA, for example, has greater impact strength than conventional soda-lime glass and similar impact strength compared to tempered glass. If it does break, PMMA sheets usually shatter into large shards with edges much smoother than those of broken glass, thus offering improved safety for end users. In addition, PMMA has a lower thermal conductance compared to glass. Finally, PMMA has higher optical transmission and clarity compared to conventional glass, which helps to compensate for loss of transparency in cases where functional coatings, such as solar-control and/or low-E coatings, are applied to the glazing for added spectrally selective properties (i.e., visible transmission, low-emissivity, and solar control).

The pane of the present disclosure is sized to comfortably fit into the insect screen compartment of an existing window with screen removed. Tolerance requirements for the TIM dimensions are quite loose, even in the case when the TIE provides thermal insulation associated with the large area enclosed air cavity in addition to blocking the direct IR radiation. In this case, the TIE is, for example, a silicone strip applied along the TIM perimeter. The dimension of the TIE in the direction normal to the major surface of the pane is such as to enable it to be pressed against the pane of main window (not against its frame) to form an insulating volume of air.

In other embodiments, the TIE is made of polyurethane, nitrile rubber, neoprene, or butyl rubber.

In embodiments, the TIM is a hybrid composite pane comprising a rigid pane of plastic bonded to a pane of thin glass by means of a thermoplastic interlayer, such as polyvinyl butyral (PVB), ethylene vinyl acetate (EVA), thermoplastic polyurethane (TPU), etc. Alternatively, bonding can be achieved by means of gluing the two panes with an optically clear adhesive (OCA), such as liquid OCA (LOCA). Hybrid composite panes include thin glass—polymer and thin glass—polymer—thin glass composites. Examples of glass include soda-lima silicate, aluminosilicate, lithium aluminosilicate, borosilicate, etc. A combination of a rigid plastic pane with thin glass allows achieving a lightweight design as well as to provide the feel and look of glass on the interior side of the window. One of the surfaces of the composite is coated with a solar-control coating, The existing clips of the screen compartment exert an external force on the glass of the TIM to keep the TIE compressed. This helps to minimize the heat transfer.

In an embodiment, the TIM comprises a single PMMA pane coated on its surface facing the interior of the building (opposite to the surface with the TIE) with a low-E coating. The low-E coating comprises an ITO layer. The TIE is pressed against the frame of the insect screen compartment with spring-assistant pillars.

In embodiments, the TIM is a single PMMA pane equipped with the TIE and coated on the surface facing the main window (the same surface as that supporting the TIE) with a low-E coating or solar-control coating.

In an embodiment, the TIM is a single PMMA pane equipped with the TIE and coated on the surface facing the main window with a corrosion-resistant solar-control coating. The coating comprises one layer of silver-copper-aluminum alloy sandwiched between two stacks of dielectric layers.

In an embodiment, the TIM is a single PMMA pane equipped with the TIE and coated on the surface facing the main window with a corrosion-resistant solar-control coating. In addition, the pane is coated with a low-E ITO-based coating on the surface facing the building interior.

In an embodiment, the TIM pane is a composite comprising a PMMA pane bonded to a thin aluminosilicate glass pane. The TIM is equipped with a TIE and coated on the surface facing the main window with a corrosion-resistant solar-control coating.

### BRIEF DESCRIPTION OF THE DRAWINGS

The present disclosure can be understood by considering the following drawings and the legend for the reference numerals presented further below:

FIG. 1 is a schematic cross-section of a typical window equipped with an insect screen installed in the screen compartment.

FIG. 2 is a schematic representation of a back view of the insect screen installed in the screen compartment.

FIG. 3A is a schematic front view of a thermally insulating member (TIM) supporting a thermally insulating element (TIE) comprising a strip of a compressible material.

FIG. 3B is a schematic cross-section of the TIM supporting the TIE comprising a strip of a compressible material.

FIG. 3C is a schematic cross-section of the TIM with the TIE of FIGS. 3A, 3B installed as replacement of insect screen into the screen compartment.

FIG. 3D is a schematic front view of a thermally insulating member (TIM) supporting a thermally insulating element (TIE) comprising a set of spring-assisted compressible pillars.

FIG. 3E is a schematic cross-section of the TIM supporting the TIE comprising a set of spring-assisted compressible pillars.

FIG. 3F is a schematic cross-section of the TIM with the TIE of FIGS. 3D, 3E installed as replacement of insect screen into the screen compartment.

FIG. 3G is a schematic cross-section of the spring-assisted compressible pillar.

FIG. 4A is a schematic cross-section of the window with the TIM of FIGS. 3A, 3B installed in the screen compartment and secured with an existing set of clips.

FIG. 4B is a schematic cross-section of the window with the TIM of FIGS. 3D, 3E installed in the screen compartment and secured with an existing set of clips.

FIG. 5A is a schematic cross-section of TIM 504 which is a composite of plastic pane 505 bonded to thin glass pane 525 by means of a bonding layer 509 with TIM bonded to TIE 515.

FIG. 5B is a schematic cross-section of TIM 506 comprising a bonded plastic/glass composite of FIG. 5A but coated with solar-control coating 530 disposed on the surface supporting the TIE 515.

FIG. 5C is a schematic cross-section of TIM 507 comprising a plastic pane 505 coated with a solar-control coating 530 and then bonded to a thin glass pane 525 and the uncoated surface of pane 505 permanently glued to TIE 515.

FIG. 5D is a schematic cross section of TIM 508 comprising a PMMA pane 505 coated with solar-control coating 530 and then bonded to thin glass pane 525 with bonding layer 509 and having a Low-E coating 535 applied on the surface of glass pane 525 facing building interior with TIE 515 permanently glued to the uncoated surface of PMMA pane 505.

FIG. 6A is a schematic representation of a TIM packaged in a protective corrugated cardboard box.

FIG. 6B is a schematic representation of an unpacked TIM with a protective adhesive tape being peeled off.

The accompanying drawings, which are incorporated in and form a part of this description, illustrate various embodiments of the disclosure, and together with the description, illustrate the principles of the disclosure, and enable those skilled in the art to make and use the disclosure.

### DEFINITION OF THE REFERENCE NUMERALS USED IN THE DRAWINGS

100, 400 Window
201 Screen compartment with insect screen
303, 403 TIM comprising a plastic pane and supporting a TIE
504, 604 TIM comprising a plastic pane bonded to glass with TIE on plastic side
305, 405, 505 Plastic pane
506 TIM comprising a plastic pane bonded to a glass, coated with a solar-control coating on plastic side, and supporting a TIE
507 TIM comprising a plastic pane coated with a solar-control coating and bonded to a glass. TIM also supports a TIE
508 TIM comprising a plastic pane coated with a solar-control coating and bonded to a glass. Glass is additionally coated with a low-E coating. TIM also supports a TIE
509 Bonding layer
110, 210, 410 Window frame
315, 415, 515 TIE
316, 416 TIE comprising spring-assistant pillars
317, 417 Spring-assisted pillar
318 Piston
319 Barrel
120, 420 Exterior pane of the window
321 Spring
322 Pad of the barrel
323 Pad of the piston
525 Pane of thin glass
130, 430, 530 Solar-control coating
535 low-E coating
140, 440 Interior pane of the window
645 Corrugated carboard packaging
150, 450 Window cavity
655 Protective adhesive tape
160, 260, 360, 460 Screen compartment
170, 270 Insect screen
180, 280, 480 Existing clips
485 Force vector

### DETAILED DESCRIPTION

A detailed description is provided below to facilitate a thorough understanding of the disclosed embodiments and connections thereof. The description is not limited to any particular example included herein.

Various embodiments and aspects of the disclosure will be described with reference to the details discussed below. The following description and drawings are illustrative of the disclosure and are not to be construed as limiting the disclosure. Numerous specific details are described to provide a thorough understanding of various embodiments of the present disclosure. The Figures are not to scale. Further, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

As used herein, the phrase “solar-control coating” refers to a coating based on one or more thin silver or silver alloy layers. Examples include double- and triple-silver coatings common in automotive and architectural coated glass industries. The role of the silver or silver alloy (silver alloyed with at least one of the following elements: copper, aluminum, nickel, palladium, platinum, chromium, or gold) is to partially reflect near infrared and mid-infrared electromagnetic waves while remaining highly transparent in the visible part of the spectrum. A silver based solar-control coating is considered as a “soft” coating, i.e., susceptible to scratches and other mechanical damages when left exposed and, therefore, requires additional protection and/or is usually deposited on a side of a window pane facing the IGU cavity (i.e., the space between panes).

As used herein, the phrase “low emissivity or low-E coating” refers to a “hard” coating comprising at least one transparent conducting material, such as a transparent conductive oxide. The most widely known example of this family of transparent materials is indium tin oxide (ITO). Other examples include indium zinc oxide, indium oxide, zinc oxide, and indium gallium zinc oxide. These materials have better mechanical durability compared to “soft” silver but in expense of a lower electrical conductivity. Their primary role is partially blocking the penetration of mid-infrared electromagnetic waves into the building interior or vehicle cabin.

The following terminology is used to describe the subject of the disclosure.

A glazing, or fenestration, or window is an article comprised at least one layer of a transparent material which serves to provide for the transmission of light and/or to provide for viewing of the side opposite the viewer and which is mounted in an opening in a building, wall or roof or other framing member or enclosure.

A composite is a structure comprising a pane of an optically transparent material coupled with a pane of another optically transparent material by means of bonding, such as lamination using an interlayer of thermoplastic material (e.g., PVB or TPU) or gluing at room temperature with, e.g., an optically clear adhesive (OCA), such as liquid OCA (LOCA), and then curing with UV light.

All coatings disclosed in the present disclosure refer, without any limitations, to coatings deposited in large-area industrial sputter coatings on large sheets of glass or plastic. These coated sheets are then cut to size to fit window dimensions.

In an embodiment, the present disclosure discloses a lightweight, frameless, economical, easy-to-install, and easy-to-remove retrofit thermally insulating member (TIM) comprising a single pane of plastic coated with a coating. Examples of plastic include polycarbonate (PC), polymethyl methacrylate (PMMA), polyethylene terephthalate (PET), cellulose acetate, polyvinyl chloride, etc. PMMA, for example, has greater impact strength than conventional soda-lime glass and similar impact strength compared to tempered glass. If it does break, PMMA sheets usually shatter into large shards with edges much smoother than those of broken glass, thus offering improved safety. In addition, PMMA has a lower thermal conductance compared to glass. Finally, PMMA has higher optical transmission and clarity compared to conventional glass, which helps to compensate for loss of transparency in cases where functional coatings are applied to the glazing. Examples of coating include silver-based solar-control coatings and TCO-based low-emissivity coatings. The pane of the present disclosure is sized to comfortably fit into the insect compartment of an existing window with insect screen removed. The thickness of the pane ranges from about 1.0 to about 16.0 mm, and preferably from about 1.5 to about 6.0 mm, depending on the window dimensions. The TIM may be removably secured in place using an existing set of clips located on the frame of the screen compartment. This allows, for example, to transform a dual pane insulated glass unit into a highly performing triple pane window. The dimensions of the TIM are not subjected to tight tolerances. The only requirement is that the pane must be slightly smaller than the screen compartment to ensure its comfortable fitting during expansion and contraction caused by thermal expansion. The frameless TIM supports a thermally insulating element (TIE) designed, unlike the solutions of prior art, to create a force to push the TIM away from the main window and against the frame of the screen compartment to improve thermal insulation. In other words, the force vector created by the TIE is directed away from the main window and towards the screen compartment. In this embodiment, the TIE is a set of spring-assisted pillars which provide separation between the TIM and the window. And press the pane against the compartment. The TIE is permanently attached to the pane from the main window side.

As an example, and without any limitations, the insect screen may remain in its compartment when the weather is comfortable for the window to stay open to allow air flow. During stretches of hot sunny weather, insect screens may be effortlessly replaced by the end user with low-gain solar-control TIM inserts to maximize the blockage of both near-IR and mid-IR sun radiation. High-gain TIM inserts may be installed during cold winter months to maximize energy savings by allowing more direct sun energy into the building while preventing the escape of mid-IR radiation. There is an option, of course, to have just one type of TIM insert which offers adequate performance during both hot and cold seasons.

The transparent pane of a TIM can be commercially cut to size from prefabricated coated panes or composites by any glass or plastic contractor using the dimensions provided by the end user, for example, using a dedicated online site. After the attachment of a TIE, the TIM may be shipped to or picked up by the end user for DIY installment. A TIM may be packaged in a corrugated cardboard box or another suitable packaging material for shipping and/or handling and may additionally be protected from one or both sides with a removable adhesive tape. Alternatively, TIMs may be installed by a professional.

In an embodiment, the TIM is removably installed between the window and the insect screen with the help of spring-assisted pillars. This option allows the TIM to work alongside the screen.

In an embodiment, the TIE is a compressible strip made, e.g., of silicone. It is permanently and appropriately secured using glue or a strong adhesive or fastener to the surface of the pane (comprising the TIM) facing the main window, proximate to the perimeter of the pane and along its entire length. It has a width, depending on the window size, ranging from about 0.3 cm to about 3 cm. The thickness of the TIE (the dimension in the direction normal to a major surface of the pane) is from about 1.0 to about 10.0 cm, depending on the gap between the innermost surface of the main window and the surface of the TIM which faces the window. The thickness of the TIE is chosen to create an insulated volume of air between the TIM and the window. A list of alternative materials for the TIE in this embodiment includes polyurethane, nitrile rubber, neoprene, butyl rubber, etc.

Although the transparent pane of the retrofit TIM adjoins the frame of the main window in some places, it is not attached to it with adhesive or any kind of additional fasteners. On the contrary, the pane of the TIM is positioned away from the main window, and the force vector created by the TIE is directed away from the main window and towards the screen compartment. Also, the TIM is not specifically designed to provide tight contact with the frame for its thermally insulating functionality. It is designed to be an economical yet adequate thermal insulating solution to reduce heat convection and conduction and, primarily, to reduce direct IR light due to the solar-control coating. The option of compressible TIE arranged along the entire perimeter of the TIM, however, does additionally and advantageously reduce the heat transfer by entrapping a volume of air between the retrofit pane and the main window. The fact that the TIE is in contact with the surface of the innermost pane of the window and not its frame significantly relaxes the dimensional tolerance requirements for the TIM and enables its easy and inexpensive manufacture as well as do-it-yourself installation by the end user without any professional help.

In an embodiment, the TIM may comprise a vent or a set of vents to enable air circulation between the building interior and the outdoor environment while the screen keeps insects from entering the building.

In an embodiment, the TIM is a composite pane comprising a rigid pane of plastic coated with a solar-control coating and bonded to a pane of thin glass by means of a thermoplastic interlayer, such as PVB, EVA, TPU, etc. Alternatively, bonding can be achieved by means of gluing the two panes with a LOCA. Examples of glass include soda-lima silicate, aluminosilicate, lithium aluminosilicate, borosilicate, etc. A combination of a rigid pane of plastic with thin glass allows achieving a lightweight design as well as to provide the feel and look of glass on the interior side of the window. The existing clips of the insect screen compartment exert an external force on the glass of the TIM to keep the TIE compressed. This helps to minimize the heat transfer. The thickness of the thin glass pane of the composite ranges from about 0.025 to about 2.1 mm, and preferably from about 0.5 to about 1.5 mm. The thickness of the bonding layer ranges from about 0.2 to about 2.4 mm, and preferably from about 0.3 to about 0.8 mm.

In an embodiment, the TIM comprises a coated hybrid composite pane comprising the following panes stacked in sequence: thin glass; polymer; thin glass; polymer; thin glass.

In an embodiment, the TIM is a single PMMA pane, 1.5 mm thick, equipped with the TIE and coated on the surface facing the interior of the building with an ITO-based low-E coating. The ITO layer of the coating is about 100 nm thick and is sandwiched between two silicon oxide dielectric layers, each about 25 nm thick. All layers of this coating as well as of the coatings discussed in the present disclosure are preferably disposed using sputter deposition.

In an embodiment, the TIM is a single PMMA pane, 1.5 mm thick, equipped with the TIE and coated on the surface facing the main window with an ITO based low-E coating. The ITO layer is about 100 nm thick.

In an embodiment, the TIM is a single PMMA pane, 1.2 mm thick, equipped with the TIE and coated on the surface facing the main window with a corrosion-resistant solar-control coating. The coating comprises one layer of a silver-copper-aluminum alloy (atomic weight percentage proportions are 95/3/2), 15 nm thick, sandwiched between two aluminum nitride layers, each about 25 nm thick.

In an embodiment, the TIM is a single PMMA pane coated on the surface facing the main window with a silver-based corrosion-resistant solar-control coating. In addition, the pane is coated with an ITO-based low-E coating on the surface facing the building interior. The TIE is applied on the surface having the solar-control coating.

In an embodiment, the TIM is a composite comprising a PMMA pane, about 1.5 mm thick, bonded to a thin aluminosilicate glass pane, about 0.7 mm thick, equipped with the TIE and coated on the surface facing the main window with a corrosion-resistant solar-control coating based on a silver-copper-aluminum alloy.

In an embodiment, a plastic pane, prior to being bonded to glass, is primed with a hard coating, such as wet-processed siloxane. After exposure to UV light, the hard coating forms a glassy surface. The thickness of the hard coating after curing may be between several microns to several millimeters. The hard coating may be applied to both sides or only one side of the pane considering process and application specifics.

In an embodiment, the TIM is adorned with a logo applied to one of its surfaces for decorative purposes. The logo can be semi-transparent or opaque. It can be printed or otherwise applied on any area of the TIM.

In an embodiment, the TIM is embellished by a decorative griddle, such as a grid of opaque vertical and horizontal strips dividing the field of view into smaller sections.

In an embodiment, the TIM is integrated in an operable window system wherein the outwardly openable part of the window holds the dual pane insulating glass unit (IGU) and the inward part holds an insect screen. The TIM is positioned on the room-facing side of the screen.

In an embodiment, the TIE also includes vents that can be opened or closed (for example, are made slidable), thereby permitting fresh airflow when the outwardly openable part of the window is open.

In an embodiment, the operable window is a sliding window system.

In an embodiment, the operable window is a tilt and turn window system. Further, these window systems may comprise fixed or retractable insect screens.

In an embodiment, the screen is slidable.

In an embodiment, the TIM comprises a decorative grille—a set of orthogonal strips dividing the window into smaller sections.

In an embodiment, the TIM comprises a customized logo.

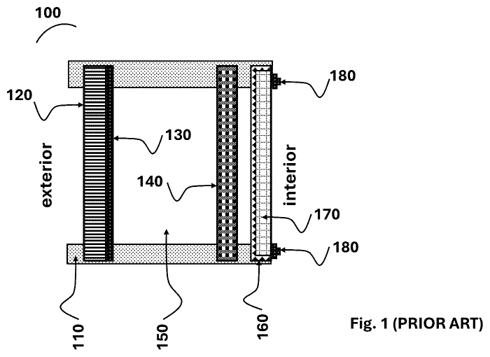

FIG. 1 demonstrates a typical two-pane window 100 comprising frame 110, one exterior optically transparent pane 120 coated with a solar-control coating 130 and one uncoated or coated optically transparent pane 140. Both panes are typically made of float glass, such as soda-lime glass. Cavity 150 between the two panes may be filled with air or, more commonly, such as in the case of performance IGU windows, with an inert gas, e.g., argon, for an improved thermal insulation. The gap between the panes ranges from about 5 and 25 mm. The window frame is equipped with insect screen compartment 160 on its interior side. The compartment accommodates a removable insect screen 170 held in place by a set of existing clips 180.

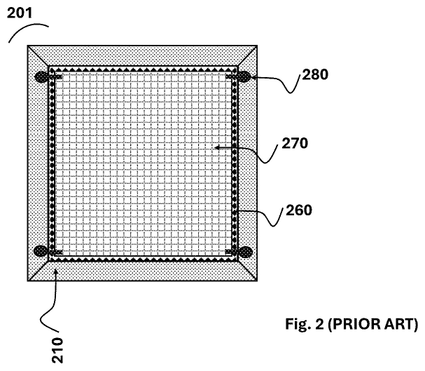

FIG. 2 demonstrates an isolated view of insect screen 270 secured in insect screen compartment 260 of window frame 210 with set of clips 280. During hot and cold seasons, when windows are kept closed most of the time, the space of insect screen compartment 260 can be used to accommodate a removable retrofit insert for improved thermal insulation of the window. Alternatively (not shown), the insert may be used between the window and the frame of the compartment.

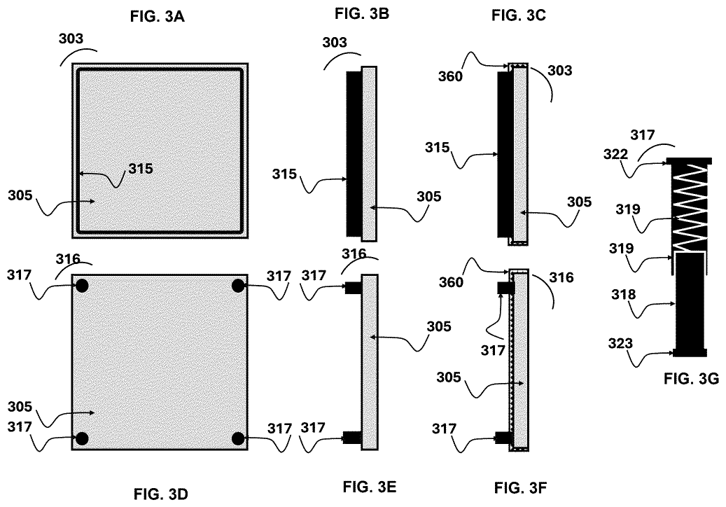

FIG. 3A demonstrates an example plane view of TIM 303 comprising single PMMA pane 305 with TIE 315 permanently glued to it. TIE 315 is a compressible strip appropriately secured proximal to the perimeter of the pane and along its entire length. A wet-deposited siloxane based protective coating (not shown) may be applied on one or both sides of PMMA pane 305 for increased scratch resistance.

FIG. 3B demonstrates a cross-sectional view of TIM 303 comprising single PMMA pane 305 with TIE 315 permanently glued to it.

FIG. 3C demonstrates a cross-sectional view of TIM 303 installed in insect screen compartment 360 as a temporary replacement of insect screen.

FIG. 3D demonstrates an example plane view of TIM 316 comprising single PMMA pane 305 with TIE 317 permanently glued to it. TIE 317 is a set of compressible spring-assisted pillars appropriately attached to the pane corners. A wet-deposited siloxane based protective coating (not shown) may be applied on one or both sides of PMMA pane 305 for increased scratch resistance.

FIG. 3E demonstrates a cross-sectional view of TIM 316 comprising single PMMA pane 305 with TIE 317 permanently glued to it. TIE 317 is a set of compressible spring-assisted pillars.

FIG. 3F demonstrates a cross-sectional view of TIM 316 installed in insect screen compartment 360 as a temporary replacement of insect screen.

FIG. 3G demonstrates a cross-sectional view of TIE 317 in the form of a compressible pillar. TIE 317 comprises piston 318 inserted into barrel 319 and attached to spring 321. Pads 322 and 323 are placed against the insert pane and the main window. Spring 321 provides pressure to push the TIM away from the window and press it, depending on the design, against either the insect screen or the frame of the insect screen compartment. In other words, the force vector of the TIE action is directed away from the main window and towards the screen compartment

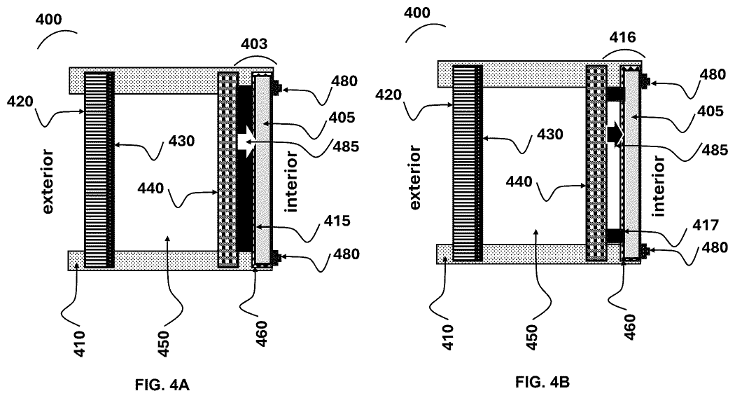

FIG. 4A demonstrates main window 400 with an exterior facing window 420 spaced from the interior pane 440 of window 400 by a window cavity 450. Window 400 is shown temporarily retrofitted with TIM 403 installed in insect screen compartment 460 instead of the insect screen. TIM 403 is secured in place with existing clips 480. Clips 480 provide external pressure to compress TIE 415 made in the form of a strip against interior pane 440 of window 400, thus providing an improved insulation to mitigate conduction and convection heat transfer. Force vector 485 shows the direction of force away from the main window 400 created by the TIE 415.

FIG. 4B demonstrates main window 400 with an exterior facing window 420 spaced from the interior pane 440 of window 400 by a window cavity 450. Window 400 is shown temporarily retrofitted with TIM 416 installed in insect screen compartment 460 instead of the insect screen. TIM 416 is secured in place with existing clips 480. Clips 480 provide external pressure to compress TIE 417 against interior pane 440 of window 400, thus providing an improved insulation to mitigate conduction and convection heat transfer. Force vector 485 shows the direction of force away from the main window 400 created by the TIE 417.

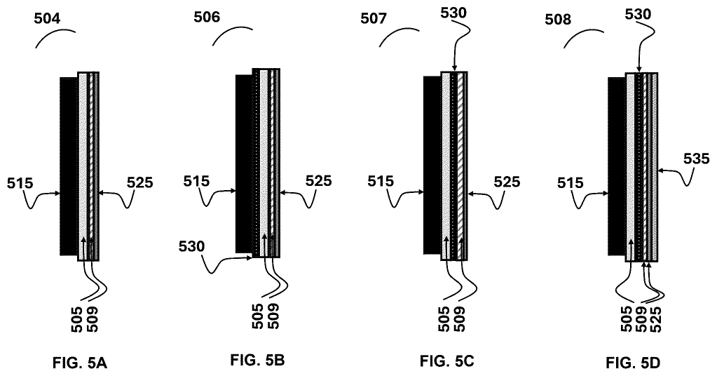

FIGS. 5A-5D depict different pane design options as alternatives to single uncoated PMMA pane 305 of TIM 303 demonstrated in FIGS. 3A-3C.

FIG. 5A demonstrates a TIM composite 504 comprising uncoated PMMA pane 505 bonded to thin glass pane 525 with bonding layer 509. The thickness of PMMA pane 505 ranges from about 1.0 to about 16.0 mm, and preferably from about 1.5 to about 6.0 mm. The thickness of glass pane 525 ranges from about 0.025 to about 2.1 mm, and preferably from about 0.5 to about 1.5 mm. Bonding layer comprises a LOCA. TIE 515 is permanently glued to PMMA pane 505.

FIG. 5B demonstrates TIM 506 comprising PMMA pane 505 bonded to thin glass pane 525 with bonding layer 509. PMMA surface of TIM 506 is coated with solar-control coating 530. TIE 515 is permanently glued to PMMA pane 505 coated with solar-control coating 530. Coating 530 is sputter deposited and comprises a layer of silver, about 15 nm thick, sandwiched between two layers of aluminum nitride, each about 35 nm thick.

FIG. 5C demonstrates TIM 507 comprising PMMA pane 505 coated with solar-control coating 530 and then bonded to thin glass pane 525 with bonding layer 509. TIE 515 is permanently glued to the uncoated surface of PMMA pane 505.

FIG. 5D demonstrates TIM 508 comprising PMMA pane 505 coated with solar-control coating 530 and then bonded to thin glass pane 525 with bonding layer 509. Low-E coating 535 is applied on the surface of glass pane 525 facing building interior. TIE 515 is permanently glued to the uncoated surface of PMMA pane 505.

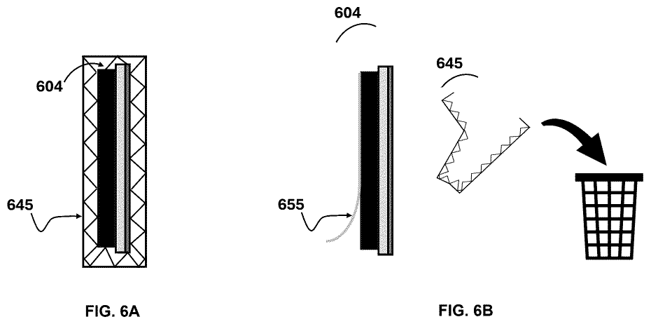

FIG. 6A is a schematic representation of a TIM packaged in a disposable or recyclable protective corrugated cardboard box while FIG. 6B is a schematic representation of an unpacked TIM with a protective adhesive tape being peeled off.

Examples of the exemplified embodiments are presented below. The disclosed examples are illustrative and should not be considered as restrictive.

### Example 1

Example one is a TIM installed as a removable retrofit for an existing reconfigurable window into insect screen compartment. The TIM comprises a single 1.5 mm thick PMMA pane with a TIE comprising four spring-assisted pillars permanently glued to the retrofit pane surface facing the window. The pillars apply pressure to the pane of the TIM to keep it secured in the compartment. The distance between the window and the pane is about 2.5 cm. The pane is sized to be about 5 mm smaller in its length and width than the length and width of the insect screen compartment to accommodate possible expansion and contraction due to temperature fluctuations. The pane is coated with a solar-control coating comprising a 15-nm thick silver-copper-aluminum alloy sandwiched between two 35-nm-thick AlN dielectric layers.

### Example 2

Example two is similar to Example one except that the insect screen is not removed from the compartment. The TIM is removably installed between the window and the insect screen. It is pressed against the screen with the TIE comprising four compressible pillars. The TIM comprises a single uncoated, about 1.5 mm thick, PMMA pane.

### Example 3

Example three is a TIM comprising a PMMA pane, about 1.5 mm thick, and a TIE comprising a silicone strip, about 5 mm wide (as measured parallel to a major surface of PMMA pane). The TIE is sized to be 3 mm longer (as measured perpendicular to a major surface of the PMMA pane) than the distance of about 2.5 cm separating the insert pane from the window. Subtracting 1.5 mm (the thickness of PMMA pane) from 2.5 cm+0.3 cm=2.53 cm, one obtains a TIE thickness of 2.38 cm. When the TIM is installed in the insect screen compartment and secured with existing set of clips, the extra 3 mm in TIE thickness allows it to be compressed firmly against the window, thus improving thermal insulation. The pane is coated with a solar-control coating comprising a 15-nm thick silver-copper-aluminum alloy sandwiched between two 25-nm-thick AlN dielectric layers.

### Example 4

Example four is similar to Example one except that the TIM comprises a composite pane comprising a 1.5 mm thick PMMA pane bonded with a LOCA to a pane of aluminosilicate glass, about 0.7 mm thick. The length of each spring-assisted compressible pillar of the TIE is about 2.4 mm. After bonding, the composite is coated on the PMMA side with a solar-control coating comprising a 15-nm thick silver-copper-aluminum alloy sandwiched between two 35-nm-thick AlN dielectric layers.

### Example 5

Example five is similar to Example four except that the TIM comprises a composite pane coated on the glass surface with a solar-control coating. The coating comprises a 15 nm thick layer made of a silver-copper-alloy and sandwiched between two sputtered aluminum nitride layers, each about 35 nm thick. The compressible pillars of the TIE are permanently glued to the coated surface of the composite.

### Example 6

Example six is similar to Example five except that the solar-control coating comprises pure silver layer, about 12 nm thick, sandwiched between two aluminum nitride layers and disposed on the thin glass surface facing the PMMA. The compressible pillars of the TIE are permanently glued to the coated surface of the composite.

### Example 7

Example seven is similar to Example three except that a low-E coating is deposed on the PMMA surface opposite to the surface supporting the TIE. The coating comprises a sputtered ITO layer, about 100 nm thick.

### Example 8

Example eight is similar to Example two except that a low-E coating is deposited on the surface of retrofit pane facing the main window. The coating comprises an ITO layer, about 100 nm, and is sputter deposited on the pane prior attaching the pillars of the TIE.

### Example 9

Example nine is similar to Example one except that the pane of the TIM is embellished with a decorative grille for aesthetic purposes.

### Example 10

Example ten is similar to Example one except that the pane of the TIM is embellished with a decorative logo for aesthetic purposes.

### Further Embodiments

In an embodiment there is provided a thermally insulating member (403) for retrofitting in a reconfigurable manner into an existing window (400), the window (400) originally including an exterior window pane (420), an interior window pane (440) spaced from the exterior window pane (420) forming a space (450) between the interior window pane (440) and the exterior window pane (420) with the interior window pane facing into an interior of a building, and an insect screen compartment (460) adjacent to, and spaced away from the interior window pane (440) on the side of the interior window pane (440) facing the interior of a building, the insect screen compartment (460) sized and configured to contain a removable insect screen (270) and being equipped with a set of original securing clips (480), the thermally insulating member (403) comprising:
an optically transparent pane (405) sized and configured to be removably secured into the insect screen compartment (460) by said set of original securing clips (480) when the insect screen (270) has been removed or in the space between the interior window pane (440) and the insect screen compartment (460) whether or not the insect screen (270) is present in the insect screen compartment (460); and
a thermally insulating element (415) permanently attached to said optically transparent pane (405) on one side thereof with the other side of the thermally insulating element (415) bearing against the surface of the interior window pane (440), and wherein the thermally insulating element (415) includes a biasing mechanism (417) to push the optically transparent pane (405) away from the interior window pane (440) and towards the insect screen compartment (460).

In an embodiment the thermally insulating element (415) is a compressible strip extending around the periphery of the optically transparent pane (405), wherein the biasing mechanism (417) is provided by the compressibility of the compressible strip.

In an embodiment the thermally insulating element (415) are compressible pillars (417) with one end thereof mounted to the optically transparent pane (405) and the other end bearing against the interior window pane (440). In an embodiment there are four of the compressible pillars (417) located at the corners of the optically transparent pane (405). In an embodiment the compressible pillars (317) comprise a piston (318) inserted into a barrel (319) and attached to a spring (321) located in the barrel (319), with pads (322) and (323) placed with the end of one pad bearing against the optically transparent pane (305) and the end of the other pad bearing against the interior window pane (440), wherein the biasing mechanism is provided by a spring (319).

In an embodiment the optically transparent pane (505) is made of a polymer, and further comprising a thin glass pane (525) bonded to one side of the optically transparent pane (505), and wherein the other side of the optically transparent pane (505) is permanently attached to the thermally insulating element (515).

In an embodiment the thermally insulating member (403) further comprises a solar-control and, or a low-E coating (530) sandwiched between the thermally insulating element (515) and the optically transparent pane (505).

In an embodiment the solar-control coating (530) comprises a layer of silver having a thickness in a range from about 10 to about 20 nm sandwiched between two layers of aluminum nitride, each about a thickness in a range from about 15 to about 45 nm.

In an embodiment the layer of silver is about 15 nm thick, and wherein the two layers of aluminum nitride each having a thickness of about 35 nm.

In an embodiment the thermally insulating member (403) further comprises a solar-control coating (530) sandwiched between the optically transparent pane (505) and the thin glass pane (525).

In an embodiment the solar-control coating (530) comprises a layer of silver having a thickness in a range from about 10 to about 20 nm, sandwiched between two layers of aluminum nitride, each about a thickness in a range from about 15 to about 45 nm. In an embodiment this layer of silver is about 15 nm thick, and wherein the two layers of aluminum nitride each having a thickness of about 35 nm.

In an embodiment the thermally insulating member (403) further comprises a solar-control coating (530) sandwiched between the optically transparent pane (505) and the thin glass pane (525), and a low-emissivity coating (535) applied on the surface of the thin glass pane (525) facing the interior of the building.

In an embodiment the solar-control coating (530) comprises a layer of silver having a thickness in a range from about 10 to about 20 nm, sandwiched between two layers of aluminum nitride, each about a thickness in a range from about 15 to about 45 nm. In an embodiment the layer of silver is about 15 nm thick, and wherein the two layers of aluminum nitride each having a thickness of about 35 nm.

In an embodiment the optically transparent pane (505) is made of polymethyl methacrylate.

In an embodiment the optically transparent pane (505) is a single uncoated optically transparent pane made of polymethyl methacrylate with a thickness from about 1 to about 16 mm.

In an embodiment the optically transparent pane (505) is a single optically transparent pane made of polymethyl methacrylate coated on its surface facing the interior of the building with a low-emissivity coating (535) and having a thickness from about 1 to about 16 mm.

In an embodiment the low-emissivity coating (535) comprises an indium tin oxide layer.

In an embodiment the optically transparent pane (505) is a composite made of a polymethyl methacrylate pane, about 2 to about 10 mm thick, bonded with a glass pane, having a thickness in a range from about 0.025 to about 2 mm thick.

In an embodiment the thermally insulating member (403) further comprises a solar-control coating (430) located on a surface of exterior window (320) that faces into the building.

In an embodiment the thermally insulating member (403) comprises a clear polymethyl methacrylate pane (405) coated with a solar-control coating (530) and having a thermally insulating element (415) permanently attached to the optically transparent pane (405) on the surface having the solar-control coating (530) applied thereto and being installed in an insect screen compartment (460) of a window (400) instead of an insect screen with the surface of the clear polymethyl methacrylate pane (405) having the solar-control coating (530) located thereon facing the exterior window (420).

In an embodiment there is provided window unit (400), comprising:
an exterior window pane (420), an interior window pane (440) spaced from the exterior window pane (420) forming a space (450) between the interior window pane (440) and the exterior window pane (420) with the interior window pane (440) facing into an interior of a building, and an insect screen compartment (460) adjacent to, and spaced away from the interior window pane (440) on the side of the interior window pane (440) facing the interior of a building, the insect screen compartment (460) sized and configured to contain a removable insect screen (270) and being equipped with a set of original securing clips (480);
a thermally insulating member (403) comprising an optically transparent pane (405) sized and configured to be removably secured into the insect screen compartment (460) by the set of original securing clips (480) when the insect screen (270) has been removed or in the space between the interior window pane (440) and the insect screen compartment (460) whether or not the insect screen (270) is present in the insect screen compartment (460); and
a thermally insulating element (415) permanently attached to the optically transparent pane (405) on one side thereof with the other side of the thermally insulating element (415) bearing against the surface of the interior window pane (440), and wherein the thermally insulating element (415) includes a biasing mechanism (417) to push the optically transparent pane (405) away from the interior window pane (440) and towards the insect screen compartment (460).

In an embodiment the window unit (400) further comprises a solar-control coating (430) located on a surface of exterior window (320) that faces into the building.

What is claimed is:

1. A thermally insulating member for retrofitting in a reconfigurable manner into an existing window, the window originally including an exterior window pane, an interior window pane spaced from the exterior window pane forming a space between the interior window pane and the exterior window pane with the interior window pane facing into an interior of a building, and an insect screen compartment adjacent to, and spaced away from the interior window pane on the side of the interior window pane facing the interior of a building, the insect screen compartment sized and configured to contain a removable insect screen and being equipped with a set of original securing clips, the thermally insulating member comprising:
an optically transparent pane sized and configured to be removably secured into the insect screen compartment by said set of original securing clips when the insect screen has been removed or in the space between the interior window pane and the insect screen compartment whether or not the insect screen is present in the insect screen compartment; and
a thermally insulating element permanently attached to said optically transparent pane on one side thereof with the other side of the thermally insulating element bearing against the surface of the interior window pane, and wherein the thermally insulating element includes a biasing mechanism to push the optically transparent pane away from the interior window pane and towards the insect screen compartment.

2. The thermally insulating member according to claim 1, wherein the thermally insulating element is a compressible strip extending around the periphery of the optically transparent pane, wherein the biasing mechanism is provided by the compressibility of the compressible strip.

3. The thermally insulating member according to claim 1, wherein the thermally insulating element are compressible pillars with one end thereof mounted to the optically transparent pane and the other end bearing against the interior window pane.

4. The thermally insulating member according to claim 3, wherein there are four of said compressible pillars located at the corners of the optically transparent pane.

5. The thermally insulating member according to claim 3, wherein the compressible pillars comprise a piston inserted into a barrel and attached to a spring located in the barrel, with pads and placed with the end of one pad bearing against the optically transparent pane and the end of the other pad bearing against the interior window pane, wherein the biasing mechanism is provided by a spring.

6. The thermally insulating member according to claim 1, wherein the optically transparent pane is made of a polymer, and further comprising a thin glass pane bonded to one side of the optically transparent pane, and wherein the other side of the optically transparent pane is permanently attached to the thermally insulating element.

7. The thermally insulating member according to claim 1, further comprising a solar-control and, or a low-E coating sandwiched between the thermally insulating element and the optically transparent pane.

8. The member according to claim 7, wherein the solar-control coating comprises a layer of silver having a thickness in a range from about 10 to about 20 nm sandwiched between two layers of aluminum nitride, each about a thickness in a range from about 15 to about 45 nm.

9. The member according to claim 8, wherein the layer of silver is about 15 nm thick, and wherein the two layers of aluminum nitride each having a thickness of about 35 nm.

10. The thermally insulating member according to claim 1, further comprising a solar-control coating sandwiched between the optically transparent pane and the thin glass pane.

11. The thermally insulating member according to claim 10, wherein the solar-control coating comprises a layer of silver having a thickness in a range from about 10 to about 20 nm, sandwiched between two layers of aluminum nitride, each about a thickness in a range from about 15 to about 45 nm.

12. The thermally insulating member according to claim 11, wherein the layer of silver is about 15 nm thick, and wherein the two layers of aluminum nitride each having a thickness of about 35 nm.

13. The thermally insulating member according to claim 1, further comprising a solar-control coating sandwiched between the optically transparent pane and the thin glass pane, and a low-emissivity coating applied on the surface of the thin glass pane facing the interior of the building.

14. The thermally insulating member according to claim 13, wherein the solar-control coating comprises a layer of silver having a thickness in a range from about 10 to about 20 nm, sandwiched between two layers of aluminum nitride, each about a thickness in a range from about 15 to about 45 nm.

15. The thermally insulating member according to claim 14, wherein the layer of silver is about 15 nm thick, and wherein the two layers of aluminum nitride each having a thickness of about 35 nm.

16. The thermally insulating member according to claim 1, wherein the optically transparent pane is made of polymethyl methacrylate.

17. The thermally insulating member according to claim 1, wherein said optically transparent pane is a single uncoated optically transparent pane made of polymethyl methacrylate with a thickness from about 1 to about 16 mm.

18. The thermally insulating member according to claim 1, wherein said optically transparent pane is a single optically transparent pane made of polymethyl methacrylate coated on its surface facing the interior of the building with a low-emissivity coating and having a thickness from about 1 to about 16 mm.

19. The thermally insulating member according to claim 18, wherein the low-emissivity coating comprises an indium tin oxide layer.

20. The thermally insulating member according to claim 1, wherein the optically transparent pane is a composite made of a polymethyl methacrylate pane, about 2 to about 10 mm thick, bonded with a glass pane, having a thickness in a range from about 0.025 to about 2 mm thick.

21. The thermally insulating member according to claim 1 further comprising a solar-control coating located on a surface of exterior window that faces into the building.

22. A thermally insulating member comprising a clear polymethyl methacrylate pane coated with a solar-control coating and having a thermally insulating element permanently attached to said optically transparent pane on the surface having the solar-control coating applied thereto and being installed in an insect screen compartment of a window instead of an insect screen with the surface of the clear polymethyl methacrylate pane having the solar-control coating located thereon facing the exterior window.

23. A window unit, comprising:
an exterior window pane, an interior window pane spaced from the exterior window pane forming a space between the interior window pane and the exterior window pane with the interior window pane facing into an interior of a building, and an insect screen compartment adjacent to, and spaced away from the interior window pane on the side of the interior window pane facing the interior of a building, the insect screen compartment sized and configured to contain a removable insect screen and being equipped with a set of original securing clips;
a thermally insulating member comprising an optically transparent pane sized and configured to be removably secured into the insect screen compartment by said set of original securing clips when the insect screen has been removed or in the space between the interior window pane and the insect screen compartment whether or not the insect screen is present in the insect screen compartment; and
a thermally insulating element permanently attached to said optically transparent pane on one side thereof with the other side of the thermally insulating element bearing against the surface of the interior window pane, and wherein the thermally insulating element includes a biasing mechanism to push the optically transparent pane away from the interior window pane and towards the insect screen compartment.

24. The window unit according to claim 23 further comprising a solar-control coating located on a surface of exterior window that faces into the building.
